(19) United States
(12) Patent Application Publication
(10) Pub. No.: US 2017/0083223 A1
(43) Pub. Date: Mar. 23, 2017

(54) DIGITAL DISPLAY SYSTEM AND METHOD

(71) Applicant: SELECTASIGN LLC, Pelham, NY (US)

(72) Inventors: EDWARD DINTRONE, Pelham, NY (US); Joseph Dagrosa, JR., Coral Gables, FL (US)

(73) Assignee: SELECTASIGN LLC, Pelham, NY (US)

(21) Appl. No.: 15/274,443

(22) Filed: Sep. 23, 2016

Related U.S. Application Data
(60) Provisional application No. 62/222,684, filed on Sep. 23, 2015.

(51) Int. Cl. G06F 3/0484; G06Q 30/02; G06F 3/0482

(52) U.S. Cl. CPC G06F 3/04847; G06F 3/0482; G06Q 30/0264; G06Q 30/0273

(57) ABSTRACT

Embodiments of the invention provide a billboard display method and system configured for at least partial, remote control by a viewing user using a messaging application. The viewing user can be a user positioned within a viewing distance and line of sight of the billboard and actually physically observing at least a portion of the billboard display by looking at or towards the billboard display. Further, the billboard information provided by the viewing user can be based on the viewing users observation of the billboard display and anything displayed on the billboard display. Some embodiments include a camera coupled to the billboard image server and positioned in a line of sight of at least a portion of the billboard display. The billboard information can be based on the viewing user viewing at least a portion of the billboard display via the at least one camera.

### RELATED APPLICATIONS

This application claims priority to United States provisional application Ser. No. 62/222,684, entitled DIGITAL DISPLAY SYSTEM, filed on Sep. 23, 2015, the entire contents of which are incorporated herein by reference.

### BACKGROUND

Digital displays are increasingly commonly used for advertising and bringing attention to various topics or subjects. People are understandably excited when featured upon such a display, as shown at many professional athletic and other events. Individuals have typically not been able to control such displays to feature content the individuals choose.

### SUMMARY

Some embodiments provide a billboard display system comprising a computer system including at least one processor and at least one coupled billboard display configured for at least partial, remote control by a viewing user using a messaging application. In some embodiments, the system comprises a digital display control system coupled to at least one source of billboard control data. The digital display control system comprises a link to a billboard image server coupled to a command interface of the messaging application. In some further embodiments, at least a portion of the at least one coupled billboard display is configured to respond to the control data through the command interface based at least in part on billboard information provided by the viewing user and the billboard image server.

In some embodiments, the viewing user is a user positioned within a viewing distance and line of sight of the billboard and actually physically observing at least a portion of the billboard display by looking at or towards the billboard display. In other embodiments, the billboard information provided by the viewing user is based on the viewing user's observation of the billboard display and anything displayed on the billboard display.

In some embodiments of the invention, the billboard information provided by the viewing user is based on the viewing user's observation of the billboard display and anything currently displayed on the billboard display based on the billboard information provided to the digital display control system by the viewing user.

Some embodiments include at least one camera coupled to the billboard image server. In some embodiments, the at least one camera is positioned in a line of sight of at least a portion of the billboard display. In some embodiments, the billboard information is based at least in part on the viewing user viewing at least a portion of the billboard display via the at least one camera. In other embodiments, the billboard information is one or more images of the billboard display taken by the at least one camera.

In some embodiments, the digital display control system is configured to transmit a push notification to a coupled device of the viewing user indicative of a billboard display of billboard information provided at least in part by the viewing user. In some embodiments, the billboard display is configured to be updated by the digital display control system using the billboard information based on one or more specified times or intervals.

In some embodiments of the invention, the specified times or intervals are controlled by the viewing user. In some embodiments, at least a portion of the at least one coupled billboard display is configured to respond to the control data within one or more specified timeslots. In some further embodiments, the time slots are saleable to the viewing user, and anything currently displayed on the billboard display based on the billboard information provided to the digital display control system based on one or more purchased time slots.

Some embodiments include a billboard display server system comprising a computing device comprising at least one processor, and a non-transitory computer readable medium, having stored thereon, instructions that when executed by the computing device, cause the computing device to perform at least some operations within a billboard controller that modify at least a portion of a billboard display at least partially under remote control by a viewing user.

In some embodiments, the operations comprise at least execution of a browser program to deliver user-selectable messaging content on a local or consumer device, and displaying at least one selectable option of a billboard message to a viewing user. Further, the operations include receiving input from the viewing user through the local or consumer device and storing the received selection in a data repository. Further, the operations include operating a digital display control system to fetch billboard image data from a billboard image server based at least in part on the received selection, and updating the billboard display based at least in part on the received input provided by the viewing user and the billboard image server.

Some embodiments include the system with at least one camera coupled to the billboard image server and positioned in a line of sight of at least a portion of the billboard display. In some further embodiments, the billboard update is based at least in part on the viewing user viewing at least a portion of the billboard display from one or more images of the billboard display taken by the at least one camera.

In some embodiments, the digital display control system is configured to transmit a push notification to the local or consumer device indicative of a billboard display of the input provided by the viewing user. In some embodiments, the digital display control system updates the billboard display based on one or more specified times or intervals provided by the viewing user. In some further embodiments, the updates of the billboard display occur between timeslots. In other embodiments, the timeslots include viewing user purchased timeslots.

### DESCRIPTION OF THE DRAWINGS

FIG. 1A illustrates a system architecture of a digital billboard display system and method according to some embodiments of the invention.

FIG. 1B illustrates an API framework of the system architecture of FIG. 1A according to some embodiments of the invention.

FIGS. 1C-1D illustrate an application process of the system architecture of a digital billboard display system and method according to some embodiments of the invention.

FIG. 1E illustrates an operations flow chart of the digital billboard display system and method according to one embodiment of the invention.

FIG. 2 illustrates a camera software system and method of the digital display system and method of FIG. 1A in accordance with some embodiments of the invention.

FIG. 3A illustrates a client-side camera software system and method of the digital display system and method of FIG. 1A in accordance with some embodiments of the invention.

FIG. 3B illustrates a server-side camera software system and method of the digital display system and method of FIG. 1A in accordance with some embodiments of the invention.

FIG. 4A illustrates user methods of the digital display system and method of FIG. 1A in accordance with some embodiments of the invention.

FIG. 4B illustrates partner methods of the digital display system and method of FIG. 1A in accordance with some embodiments of the invention.

FIG. 4C illustrates operator methods of the digital display system and method of FIG. 1A in accordance with some embodiments of the invention.

FIG. 4D illustrates administrator methods of the digital display system and method of FIG. 1A in accordance with some embodiments of the invention.

FIGS. 5A-5D illustrate user application wireframe displays of the digital display system and method of FIG. 1A in accordance with some embodiments of the invention.

FIG. 6 shows a database and server architecture for operating a digital display system and method according to one embodiment of the invention.

FIG. 7 shows a system for operating a digital display system and method of the system architecture of FIG. 1A according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments, and of being practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Some embodiments of the invention can include a system comprising or coupled to one or more digital displays that can be controlled or manipulated by one or more users. In some embodiments, a user can post one or more messages on one or more billboard displays using the system. For example, some embodiments include a system and method capable of providing a do-it-yourself billboard using a messaging application coupled to a digital display controller and optionally coupled to a high-resolution camera. Some embodiments include a computer with an attached camera (e.g., such as Raspberry Pi™) and an internet connectivity device on the inside sill of a window in a building directly across the street from the billboard. The computer can be programmed to continually check the digital display system and method database for messages uploaded by application users and to take a picture when messages are scheduled. In some embodiments, photos are immediately or promptly linked to user's “Your Messages” screen for downloading and sharing. Some embodiments of the invention enable users to schedule and upload messages directly onto outdoor or indoor digital billboards. Raspberry Pi™ is a trademark of the Raspberry Pi Foundation.

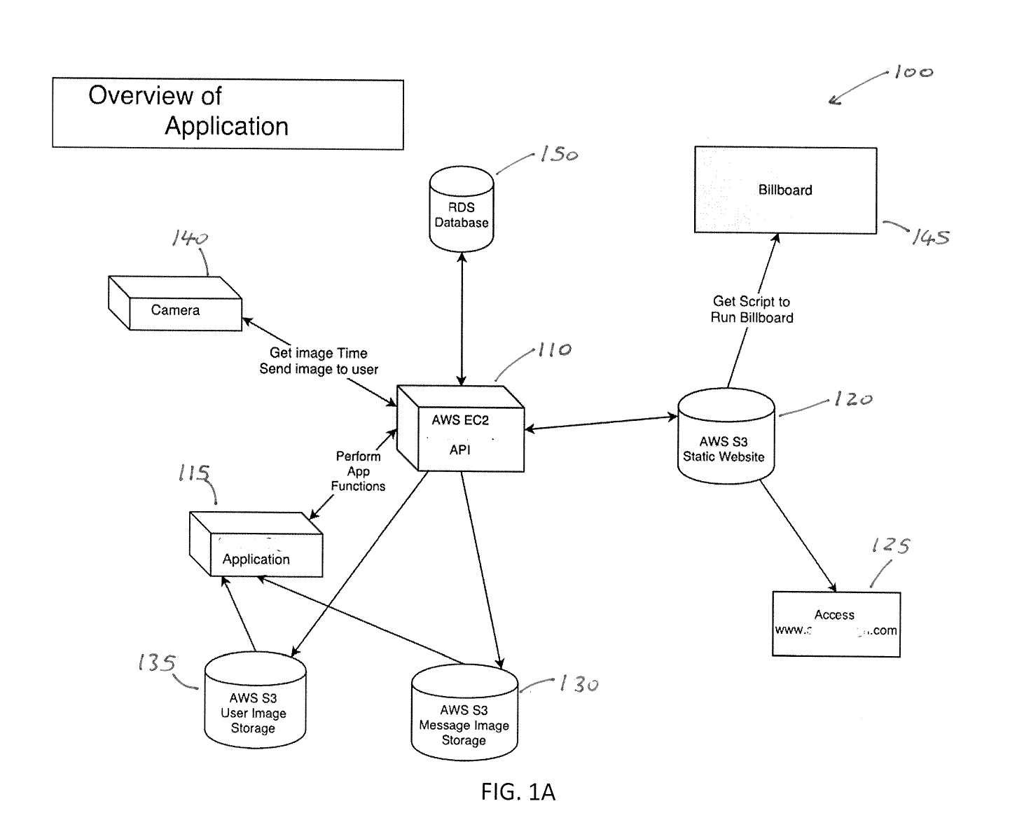

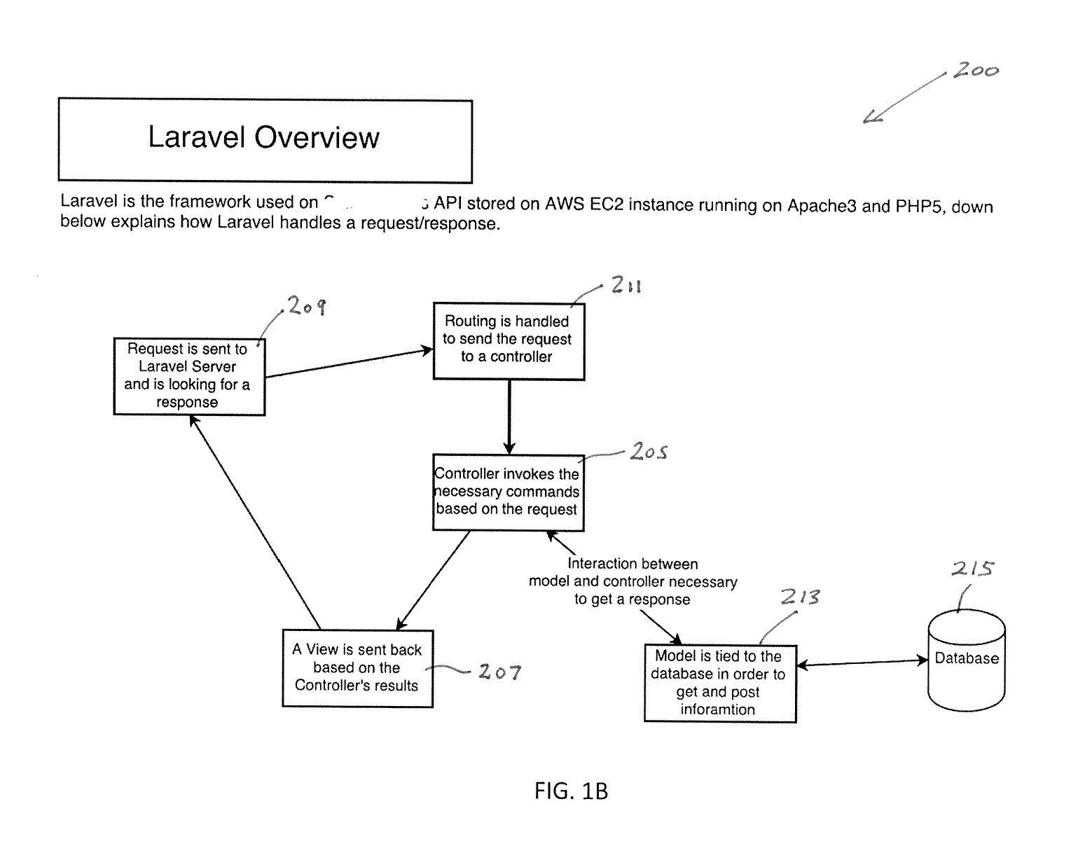

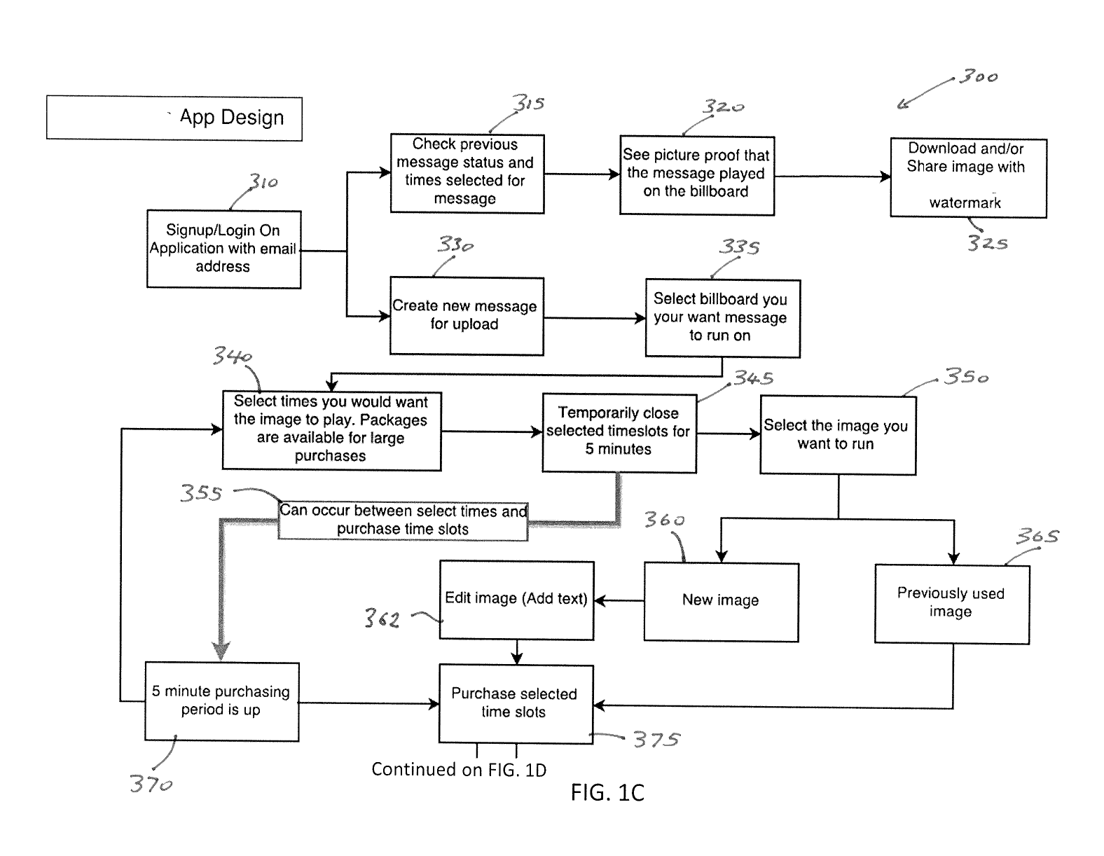

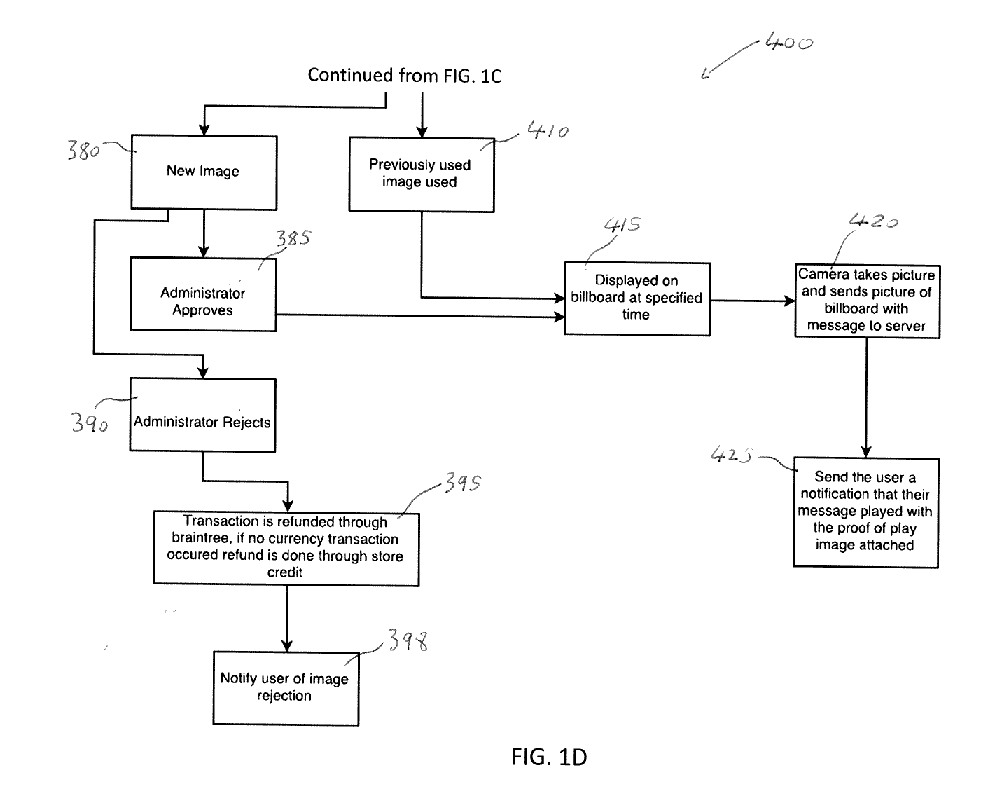

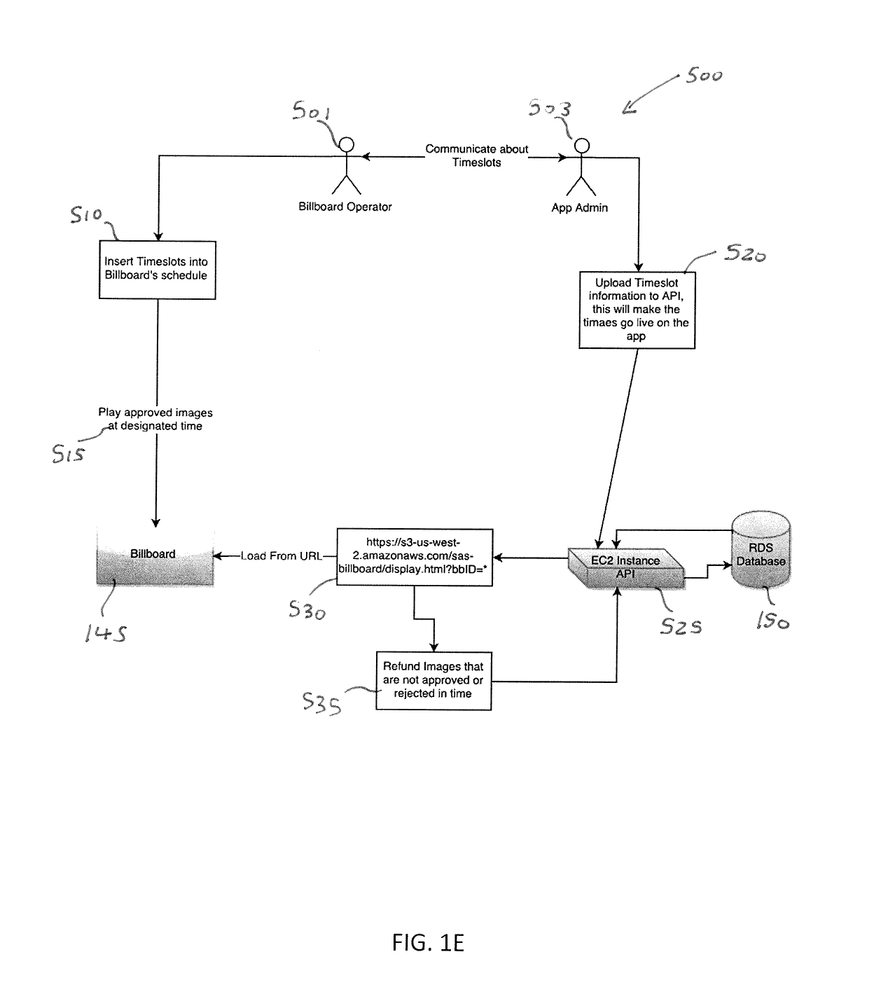

Some embodiments include a digital display system and method application configured to enable users to upload images freely from their mobile device to an electronic billboard. From this function, the user can gain the satisfaction of having their image displayed on the electronic billboard, a picture memento that they will receive through our camera capturing a picture of the billboard with their image playing, and a public reputation from their message (often desirable for targeting the small businesses). In some embodiments, in order for the user to upload an image to the billboard, they must follow various steps that are detailed in the various processes of a system architecture 100 of a digital billboard display system and method shown in FIG. 1A described in the following.

FIG. 1A illustrates a system architecture 100 of a digital billboard display system and method according to some embodiments of the invention. In some embodiments, the system architecture 100 can include an assembly of coupled devices and systems for image capture, image storage, image selection, and image display. Further, any of the coupled devices or systems can communicate data and information from or to another coupled device or system using at least one application program interface (“API”). For example, some embodiments include a digital billboard display system application program interface (“API”) 110. In some embodiments, the digital billboard display system API 110 can couple to a digital billboard display application 115 to perform various functions of the digital billboard display system and method. In some embodiments, the digital billboard display system API 110 can couple to a camera 140 configured for capturing images and capturing the image time.

In some embodiments of the invention, the digital billboard display system API 110 and/or the digital billboard display application 115 can couple to one or more databases for image storage and retrieval. For example, in some embodiments, the digital billboard display system API 110 can couple to a relational database service database 150, message image storage 130, and/or user image storage 135 databases. Further, the digital billboard display application 115 can couple to the message image storage 130, and/or user image storage 135. In some embodiments, the digital billboard display system API 110 can couple to a static website 120, from which a script can be accessed to run a billboard 145, and a digital billboard display system and method can be accessed through access gateway 125. Further, some embodiments include a digital billboard display system and method administrator website that is publicly accessible. Users can access the website to review FAQ, terms of use, privacy policy, and contact the system owner. Some embodiments include a password protected portion of the administrator website that is used only by digital display system and method staff (administrators) and by billboard owners, where staff can use the site to enter billboard information. This includes the address, screen dimensions, and images of the board. It is also used to enter application schedules by billboard that are reflected on the application as the available timeslots for users. In some embodiments, staff can also approve or reject uploaded messages (1st screening level) and monitor the fill rate of the timeslots. Further, a billboard owner can use the administration website primarily to confirm schedules and to approve/reject messages (2nd screening level). Other or additional screening levels can be used in some embodiments. The administrator can approve/deny messages, manage billboards and timeslots, and see statistical information about the application. A billboard operator is the person in charge of managing the application for certain billboard/s. They are the intermediate step that allows the app to be used for the selected billboard. They control two key features that allow the application to function. For example, an “Approve/Deny” timeslot requested times can allow the billboard administrator to verify that the times proposed in application for their billboard have already been previously approved by them, meaning that we have the right to sell these timeslots so they go live on the application if the operator hits approve. Further, an Approve/Deny messages can be administered that will go up on the billboard. An administrator is the person that manages the application. They are the users that maintain the application, making sure it is still running. They have many key features necessary for the application, including, but not limited to, “Add/Remove billboards and operators”, where they have the ability to add new billboards for the application and add operators to correspond with those billboards. Further “Add timeslot times”, where they are able to add new times into the application by reserving more time with the billboard so the application can be displayed on the billboard. These times will need to be approved by the operator. When adding a timeslot, they can select the time, the billboard, the price per X seconds, the duration of the timeslot, and the minimum duration that must be purchased (defaults to 10 seconds). Further, “Approve/Deny messages”, similar to the operator, where the administrator must approve of messages. Any approved messages are forwarded to the operator of the billboard to be approved.

Once approved, this message is approved by the administrator across all billboards, versus when the operator approves, they only approve for their billboard. Further, statistical information can also be provided for both the administrator and the operator. The administrator can view all billboards while the operator can only view their own billboards. More statistical information will be implemented including monthly revenue, percentage of timeslots sold, list of all approved messages, list of all rejected messages, etc. These will be necessary when trying to analyze timeslots and to help determine what timeslots are the most cost efficient. In some embodiments, the technologies used to accomplish the above-mentioned operations include AWS™ EC2™ Instance, AWS™ RDS™ Database, Apache 3, Laravel™, PHP, MySQL™, Twitter® Bootstrap 3.0 Front-End CSS, JavaScript™, AngularJS®, Composer Package Manager, and Braintree™. Amazon Web Services, the “Powered by Amazon Web Services” logo, AWS, EC2, S3 and RDS are trademarks of Amazon.com, Inc. or its affiliates in the United States and/or other countries. Laravel™ is a trademark of Taylor Otwell. MySQL is a trademark of Oracle Corporation and/or its affiliates. Twitter® is a registered trademark of Twitter, Inc. of San Francisco, Calif. JavaScript is a registered of Oracle Corporation and/or its affilaites. Braintree™ is a trademark of Paypal, Inc.

In some embodiments, the digital billboard display system and method can comprise one or more server systems and/or hosting solutions. For example, FIG. 1B illustrates an API framework 200 of the system architecture 100 of FIG. 1A according to some embodiments of the invention. In some embodiments, the digital billboard display system API 110 can comprise a process 205 that can comprise a controller invoking the necessary commands based on the request where a process 211 can comprise routing handled to send the request to a controller. In some embodiments, a process 207 can comprise a view being sent back based on the controllers results, and a process 209 can comprise a request being sent to a Laravel™ server looking for a response. In some embodiments, process 213 can include a model tied to the database 215 in order to get and post information.

FIGS. 1C-1D collectively illustrate an application process 300 of the system architecture of a digital billboard display system and method 100 according to some embodiments of the invention. The application process 300 can be configured or enabled by one or more software applications of the display system and method 100. Referring initially to FIG. 1C showing a portion of the application process 300, some embodiments include a sign-on process 310 where a user can sign-up and/or login using an email address or other conventional identification method. In some embodiments, process 315 can include checking a previous message status and times selected for the message. Some embodiments include a process 320 can include seeing actual picture or visual proof that the message is played on the billboard. In some embodiments of the invention, the process 325 can include downloading and/or sharing an image with a watermark. In some embodiments, the process 330 can include creating a new message for upload. Some embodiments include a process 335 that can include selecting a billboard for running messages. In some embodiments of the invention, process 340 can include selecting times for image display where packages are available for large purchases. In some embodiments, process 345 can include temporarily closing selected timeslots for five minutes. In some embodiments, process 350 can include selecting the image to run. In some embodiments, process 355 can include occurrences between select times and purchase time slots. Some embodiments include process 360 that can include a new image, process 362 can include editing image and process 365 can include the use of a previously used image. In some embodiments, the process 370 can include five minute purchasing period is up, and the process 375 can include purchase selected time slots.

Referring to FIG. 1D, continued from FIG. 1C, with portion 400 of the application process 300, in some embodiments, the process 380 can include new image and process 385 can include an administrator approves step. In some further embodiments, process 390 can include administrator rejects, and process 395 can include the transaction being refunded. In some embodiments, the process 398 can include notifying the user of image rejection, and process 410 can include previously used image functionality. In some embodiments, process 415 can include displaying on billboard at a specified time, and process 420 can include camera 140 taking a picture and sending the picture of the billboard with a message to server. Further, some embodiments include process 425 including sending the user a notification that their message played with the proof of play image attached.

In some embodiments, the digital display system and method 100 can include an operations page that can be used to help manage the application from the administrator/billboard operator view. The main purpose of this page is to approve or deny messages, manage billboards and timeslots, and provide statistical information about the application. The operations page can be separated into two versions, one version for an administrator which opens up the entire functionality of the operations page, and a second version configured for a billboard operator, which closes off most of the operations page to them. In some embodiments, a billboard operator can be defined as the person in charge of managing the digital display system and method 100 application for certain billboards. The billboard operator can operate as an intermediary that allows the application to be used for the selected billboard. In some embodiments, the billboard operator can control two key features that allow the application to function. Some embodiments include approve/deny timeslot requested times functionality. This allows the billboard administrator to verify that the times proposed for a billboard that have already been previously approved by them, and the right to sell these timeslots so they go live on the application if the operator approves. For approve/deny messages, billboard operator approval is the final step a message needs in order to be displayed on a billboard.

In some embodiments, an application administrator can be a person that manages the application from the digital display system and method 100. The application administrator can be a user that maintains the application, and can add/remove billboards and operators, with the ability to add new billboards for the application and to add operators to correspond with those billboards. In some embodiments, other application administrator managed functions include add timeslot times, where the administrator can add new times into the application by reserving more time with the billboard so the digital display system and method application can be displayed on the billboard. In some embodiments, these times need to be approved by the operator. In some embodiments, when adding a timeslot, the application administrator can select the time, the billboard, the price per X seconds, the duration of the timeslot, and the minimum duration that must be purchased (which defaults to 10 seconds in some embodiments,). In some embodiments, other application administrator managed functions include approve/deny messages where the administrator must approve messages. In some embodiments, any approved messages can be forwarded to the operator of the billboard to be approved. In some embodiments, once approved, this message can be approved by the administrator across all billboards, versus when the operator approves, they only approve for their billboard. In some embodiments, statistical information can be provided for both the administrator and the operator, the difference being that the administrator can view all billboards while the operator can only view their own billboards. Further, in some embodiments, other statistical information can be provided including monthly revenue, percentage of timeslots sold, list of all approved messages, list of all rejected messages, etc. These can be necessary when trying to analyze timeslots, and to help determine what time of day timeslots are the most cost efficient. In some embodiments, the technologies used for the ops page can be AWS EC2 CentOS Dedicated Server, Apache 3, PHP, MySQL™, Twitter® Bootstrap 3.0 Front-End CSS, Composer Package Manager.

FIG. 1E illustrates an operations flow chart 500 of a digital billboard display system and method 100 according to one embodiment of the invention. In some embodiments, a billboard operator 501 and/or an application administrator 503 can receive information regarding timeslots. In some embodiments of the invention, the process 510 can include insert timeslots into billboard's schedule, and process 515 can include playing approved images on the billboard 145 at a designated time defined by one or more of the timeslots. In some embodiments of the invention, process 520 can include uploading timeslots information to an API to make times go live on the billboard 145. In some embodiments, software API 525, coupled to RDS' database 150, can facilitate processing of access weblink 530 (URL webpage) and display of an image on the billboard 145. In some embodiments, process 535 can refund images that are not approved or rejected in time. In some embodiments, the application communicates with the billboard through a URL webpage that the billboard pulls from at the designated time. In some embodiments, D3 software that can be running on the Ripley's billboard in Time Square has certain functionality that allows the user to enter in a URL to import the necessary data. Some embodiments also offer a feature that allows the user to type in exactly what time of day they wish to get the server to read from that URL. Using these features in some embodiments, users can be allowed to transfer the data from the application to the billboard, and can reserve certain times of the day to run the application.

In some further embodiments, data from the server data importation can utilize a URL, and run timeslots based on the inputted time (instead of running what is supposed to be running at the time the billboard server runs the URL). In other words, if there is only an estimated time that the images will show on screen, the billboard URL can load those images at any time of the day using the estimated time as one of the URL parameters. These embodiments provide the flexibility to work with billboards used in the sports industry. For example, with a billboard that is scheduled to run a digital billboard display system and method 100 application during a fourth quarter intermission of a football game, the exact time it will run is unknown, but an estimated time (e.g., 8:00 pm) is known. Using this embodiment, the digital billboard display system and method 100 can run the 8:00 p.m. timeslot at any desired time during the game. In some embodiments, the technologies used for loading the images on the billboard can include, but not be limited to, a AWS EC2 CentOS Dedicated Server, Apache 3, MySQL™, PHP, and/or Javascript™/AJAX.

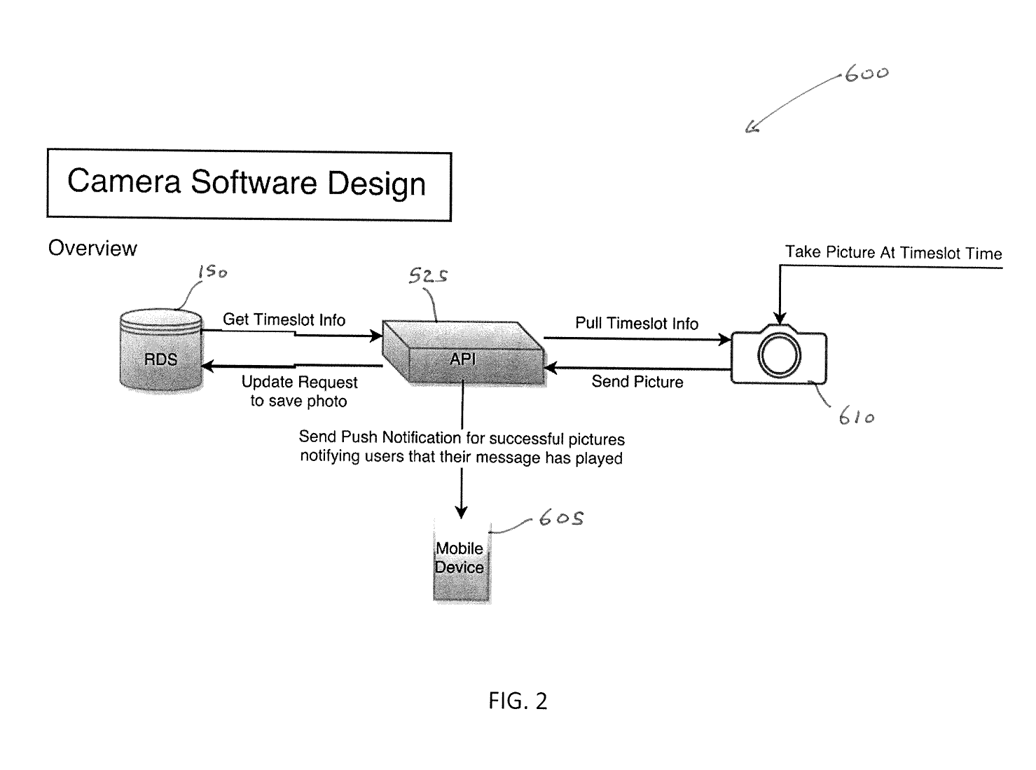

As described earlier, in some embodiments, the digital billboard display system API 110 can couple to a camera 140 configured for capturing images and capturing the image time. FIG. 2 illustrates a camera software system and method 600 of the digital display system and method 100 of FIG. 1A in accordance with some embodiments of the invention. In some embodiments, API 525 can process timeslot information from the RDS™ database 150, and update request to save photo. Further, in some embodiments, a push notification can be sent to mobile device 605 related to successful pictures notifying users their message has played. In some embodiments, timeslot info can be pulled to camera 610. In some embodiments, the camera 610 can take pictures at a timeslot time and send pictures to the API 525. In some embodiments, the camera 140 can comprise the camera 610.

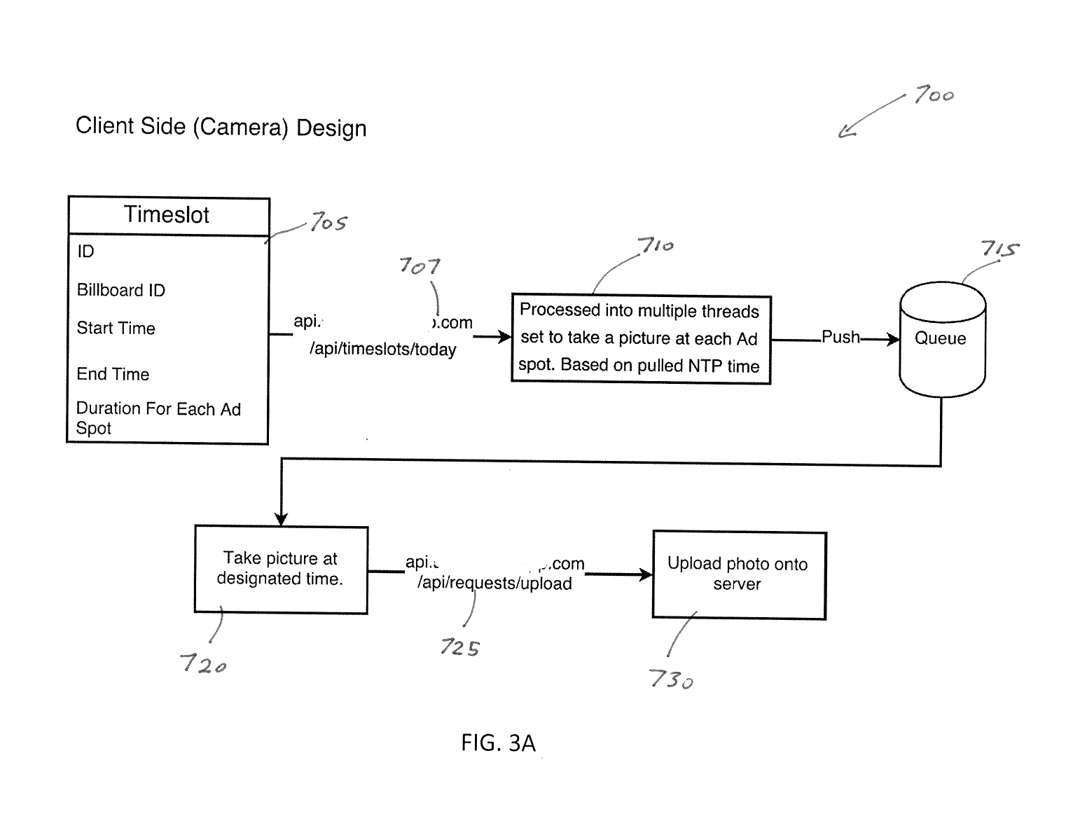

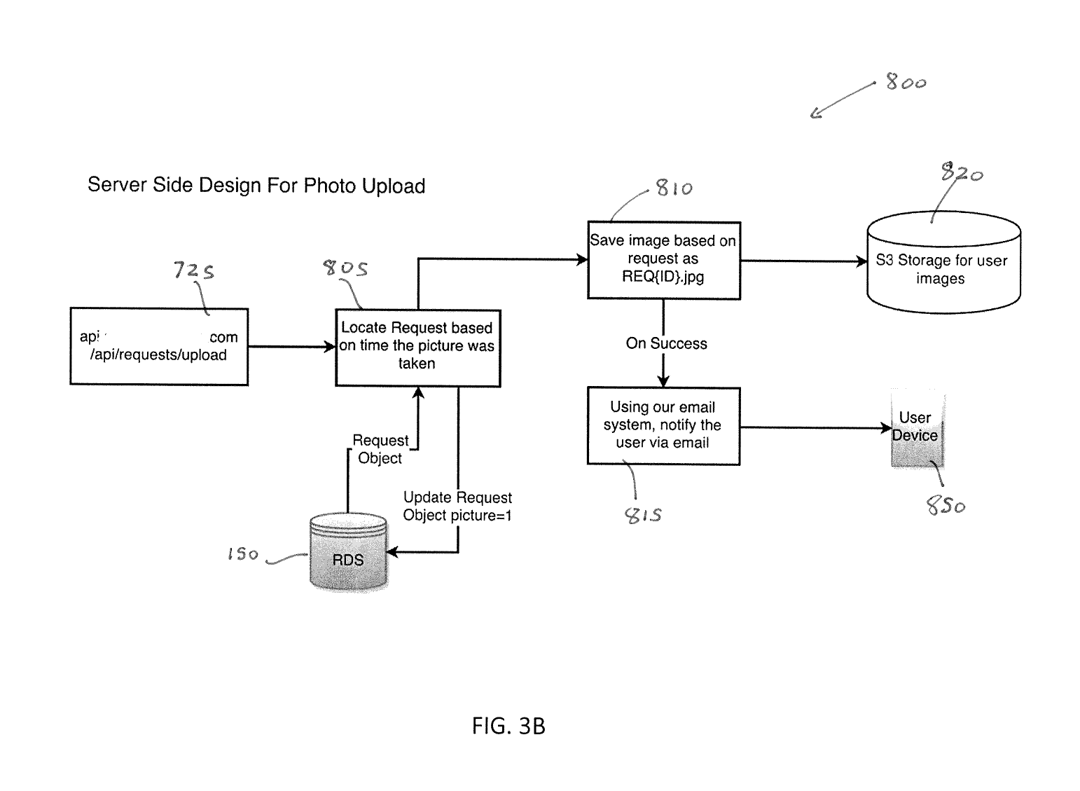

FIG. 3A illustrates a client-side camera software system and method 700 of the digital display system and method 100 of FIG. 1A in accordance with some embodiments of the invention. In some embodiments of the invention, any of the previously described timeslots can comprise timeslot 705 including ID, billboard ID, start time, end time, and duration for each ad slot. In some embodiments, through weblink 707, process 710 can comprise multiple threads set to take a picture at each Ad spot based on pulled NTP time. In some embodiments, following a push to queue 715, process 720 can include taking a picture at a designated time, and through weblink 725, process 730 to upload onto a server.

FIG. 3B illustrates a server-side camera software system and method 800 of the digital display system and method 100 of FIG. 1A in accordance with some embodiments of the invention. In some embodiments, the digital display system and method 100 camera serves the main purpose to capture photos of the billboard during the timeslot the users have purchased. These photos are shown to the user as proof of the image playing on the billboard, as well as to provide the user an additional feature allowing them to see their image in the context of the billboard with people in the vicinity. In some embodiments, from weblink 725 process 805 can include a locate request based on the time the picture was taken, and coupling through RDS database 150 with update request object picture (“=1”) and request object. In some embodiments, process 810 can include save an image based on request as “REQ(ID).jpg” (storage 820), and process 815 can include notify the user via email using the email system to user device 850.

In some embodiments, the camera system (e.g., including for example camera 610) can be fully automated and can import the time from the server and calculate when it needs to take photos of the billboard. In some embodiments, the calculation can be performed using the server time and not the camera's local time in order to keep multiple times synchronized. In some embodiments, no additional steps to incorporate new timeslots are required after the initial setup. After the camera calculates the time in which it needs to run, it can then take the photo and upload it to the server. In some embodiments, the server can then link the photo taken with the user request that was uploaded for the photo. In some embodiments, the photo is then saved into the server, and the user is notified that their message has played and that a photo of their message is available to be viewed. In some embodiments, the following technologies can be used for the camera system: Raspberry Pi™ 2 Model B, Raspberry Pi™ WiPi USB Dongle, Raspberry Pi™ Camera, VERIZON™ Jetpack 4G LTE 6620L, and Python™ 2.7. VERIZON is a registered trademark of Verizon Trademark Services LLC, Arlington, Va. Python is a registered trademark of the Python Software Foundation, Hampton, N.H., United States.

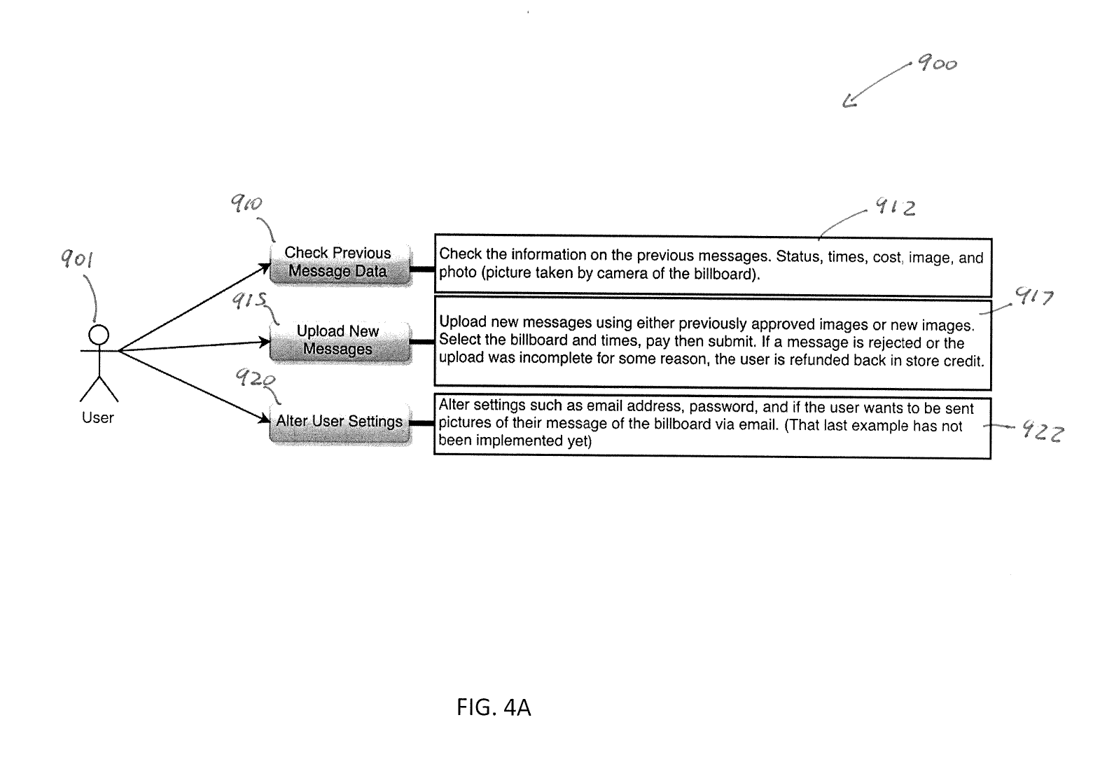

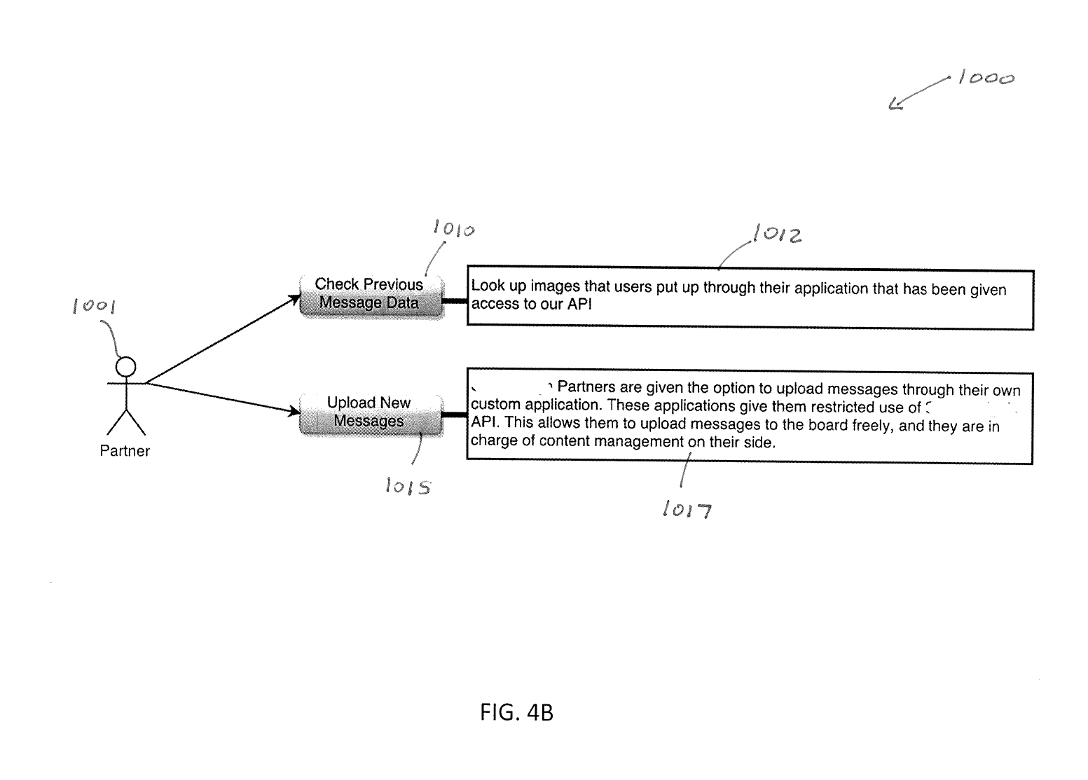

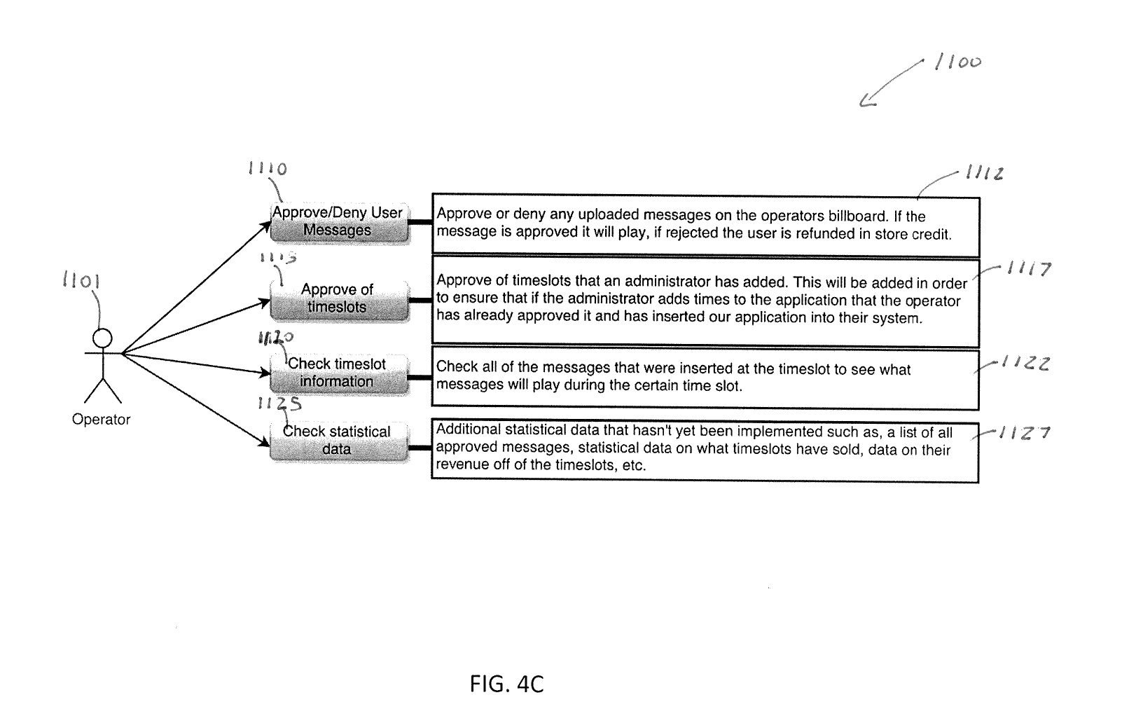

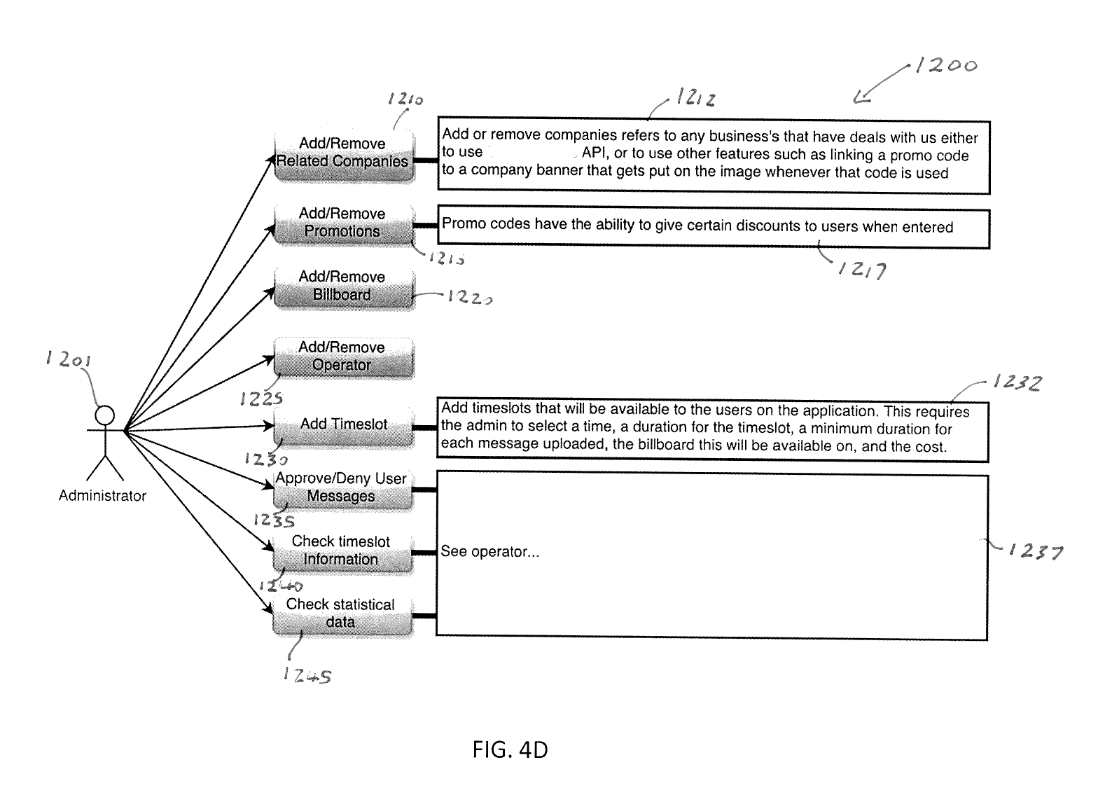

FIG. 4A illustrates user methods 900 of the digital display system and method 100 of FIG. 1A in accordance with some embodiments of the invention. In some embodiments, using digital billboard display system and method 100, the user 901 can perform a variety of processes including a process 910 that can comprise a check previous message data process 915 that can include uploading new messages, and process 920 that can include altering user settings. In some embodiments, process 910 can comprise an action or process 912 of checking the information on the previous messages including status, times, cost, image, and photo from the camera 610. In some embodiments, process 915 can comprise an action or process 917 of uploading new messages using either previously approved images or new images. Further, in some embodiments, the process 915 can include or accommodate actions or processes 917 that include selecting the billboard and times, paying and then submission. If a message is rejected or the upload was incomplete, the user can received a refund of store credit. In some embodiments, process 920 can comprise or include an action or process 922 of altering the settings such as email address and/or password, and whether or not the user wishes to receive pictures of their message of the billboard via email.

FIG. 4B illustrates partner methods 1000 of the digital display system and method 100 of FIG. 1A in accordance with some embodiments of the invention. In some embodiments, using digital billboard display system and method 100, the partner 1010 can perform a variety of processes including process 1010 including checking previous message data, and process 1015 including upload new messages. In some embodiments, procedure 1012 can include an action or process 1012 comprising look up images that users put through their application that has been given access to an API of the digital display system and method 100 (e.g., such as API 110). In some further embodiments, the process 1015 can comprise procedure 1017 including providing an option to upload messages through their own application, where the applications provide restricted use of the API 110. This can allow the user to freely upload messages to the board, while providing management of content on the user's side.

FIG. 4C illustrates user methods 1100 of the digital display system and method 100 of FIG. 1A in accordance with some embodiments of the invention. In some embodiments, using digital billboard display system and method 100, the operator 1101 can perform a variety of processes including procedures 1110 approve/deny user messages, procedures 1115, approve of timeslots, procedures 1120, check timeslot information 1120, and check statistical data 1125.

In some embodiments, the procedures 1110 can include actions or processes 1112 of approve or deny uploaded messages on the operator's billboard. In some embodiments, the digital billboard display system and method 100 can load images at specified times during the day by watching the URL given to the billboard administrators. In some embodiments, once the billboard loads the information from the URL, it can run an application that will download images with times attached to them which specifies what times those images need to be played. In some embodiments, once the images are played, a camera can take a picture of the image and the camera or system can send it out to the user. If an image that was supposed to play on the billboard was not approved in time, that image would be refunded, or if the image was rejected, the refund process already happened, and the image simply would not play. In some embodiments, technologies for loading images onto the billboard can include Amazon Web Service™ EC2™-Instance, Amazon Web Service™ S3™ Storage, Amazon Web Service™ RDS™ Database, Apache 3, MySQL™ , PHP, Javascript™ /AJAX, D3® Electronic Billboard Software (Installed on Billboard Server), and Tardis 2000 Time Sync (Installed on Billboard Server). D3® is a registered trademark of D3 LED, LLC.

In some embodiments, if a message is approved, it can play, and if rejected, the user can be refunded the store credit. Further, if the message is approved it will play, and if rejected, the user is refunded store credit. Further, the process 1150 can include actions or processes 1117 comprising approval of timeslots that an administrator has added. This can be added to ensure that the operator has already approved any times added by the administrator. Further, the process 1120 can include actions or processes 1122 comprising checking all messages that were inserted at the timeslot to see which messages will play during a certain time slot. Further, the process 1125 can include actions or processes 1127 comprising additional statistical data that hasn't yet been implemented such as, a list of all approved messages, statistical data on what timeslots have sold, data on revenue off the timeslots, etc.

FIG. 4D illustrates administrator methods 1200 of the digital display system and method 100 of FIG. 1A in accordance with some embodiments of the invention. In some embodiments, using digital billboard display system and method 100, the administrator 1201 can perform a variety of processes including procedures 1210 including add/remove related companies. Further, procedures 1215 can include add/remove promotions. Further, procedures 1220 can include add/remove billboard. Further, procedures 1225 can include add/remove operator. Further, procedures 1230 can include add timeslot. Further, procedures 1235 can include approve/deny/user messages. Further, procedures 1240 can include check timeslot information. Further, procedures 1245 can include checking statistical data. Further, procedures 1210 can include adding or removing companies where any businesses with deals ongoing can use the API or use other features such as linking a promo code to a company banner that is placed on the image whenever the code is used. Further, procedures 1215 can include promo codes that are able to give certain discounts to users when entered. Further, procedures 1230 can include adding timeslots that will be available to the users on the application. This requires the administrator to select a time, a duration for the timeslot, a minimum duration for each uploaded message, the billboard, and the cost. Further, procedures 1235, 1240, 1245 can include seeing an operator.

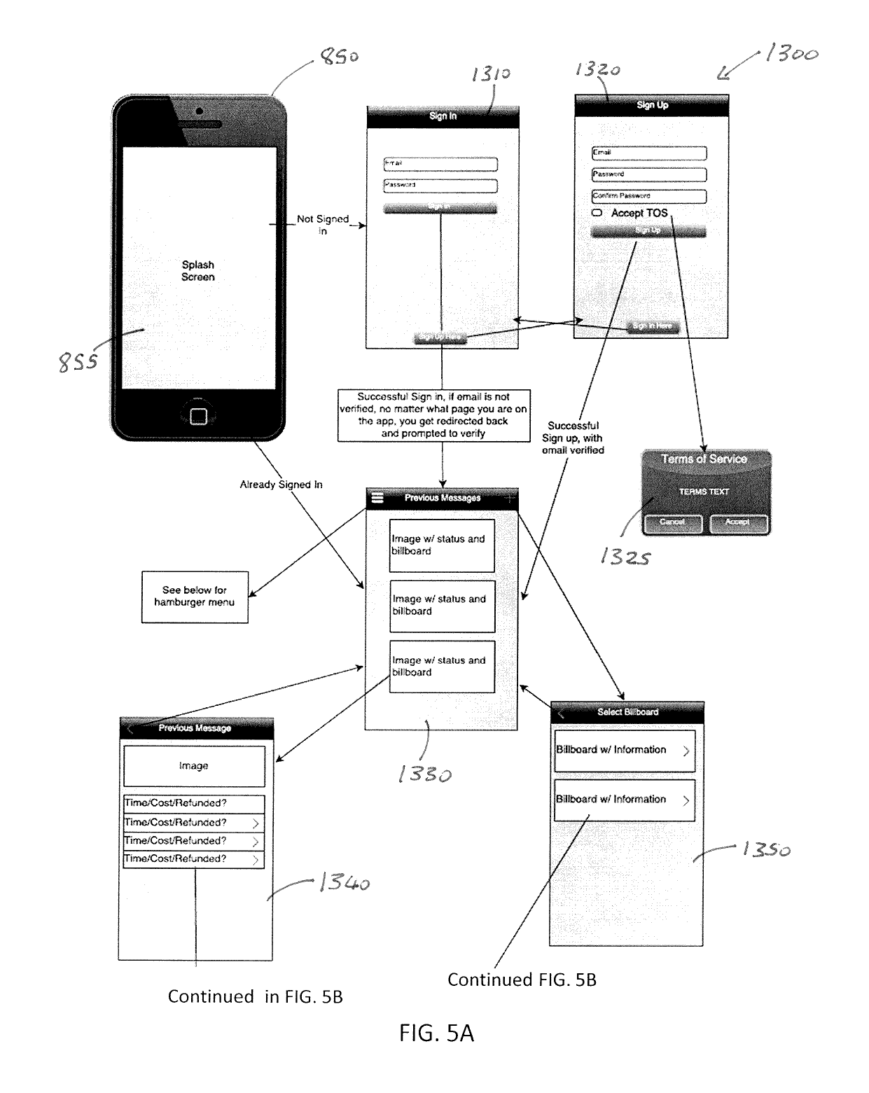

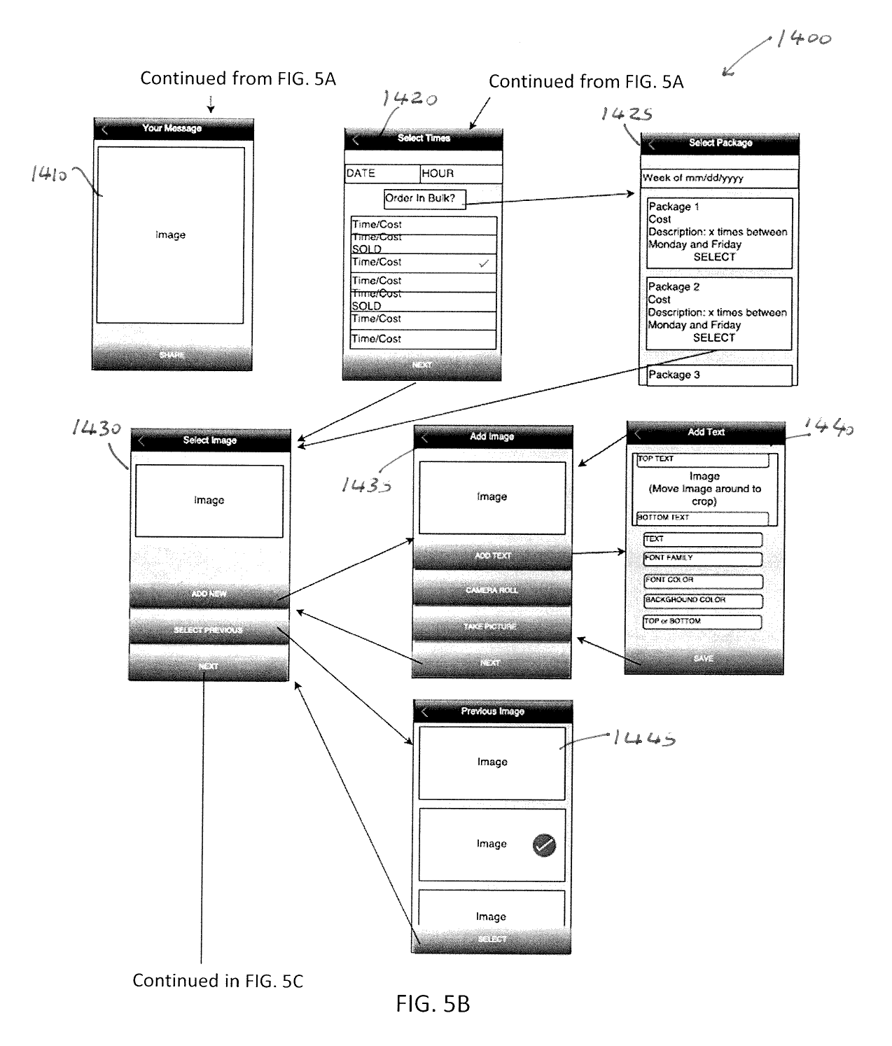

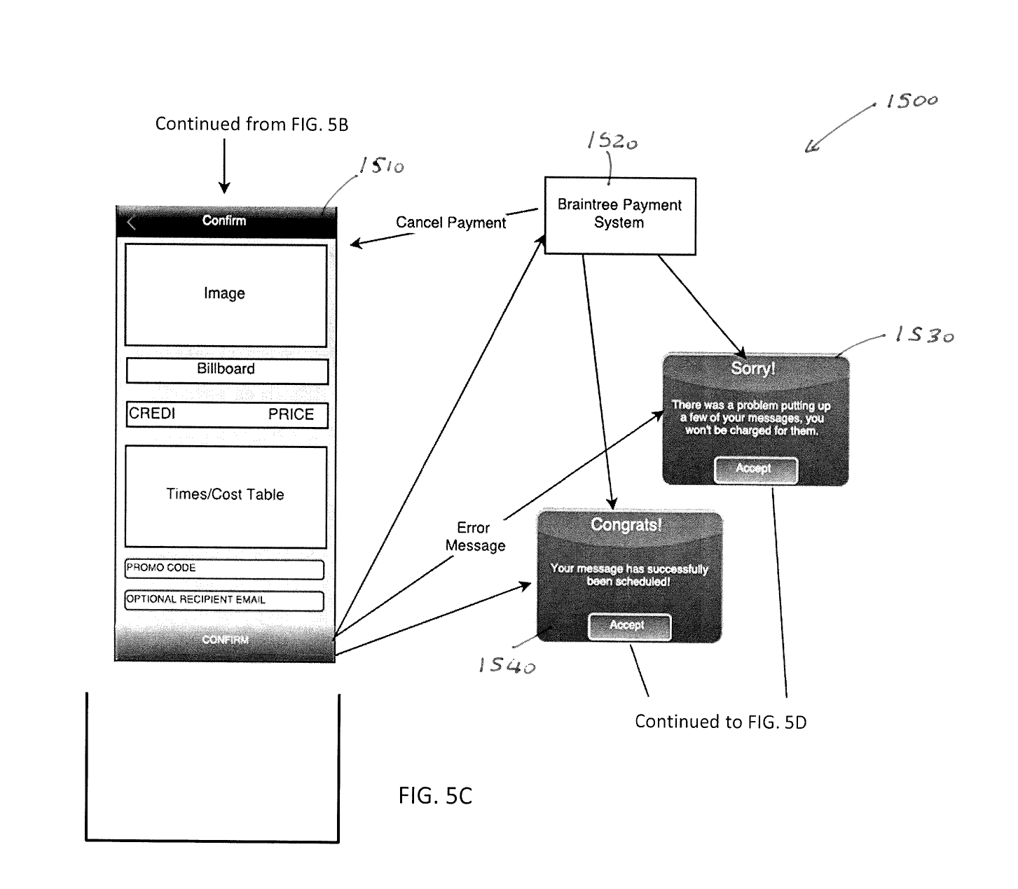

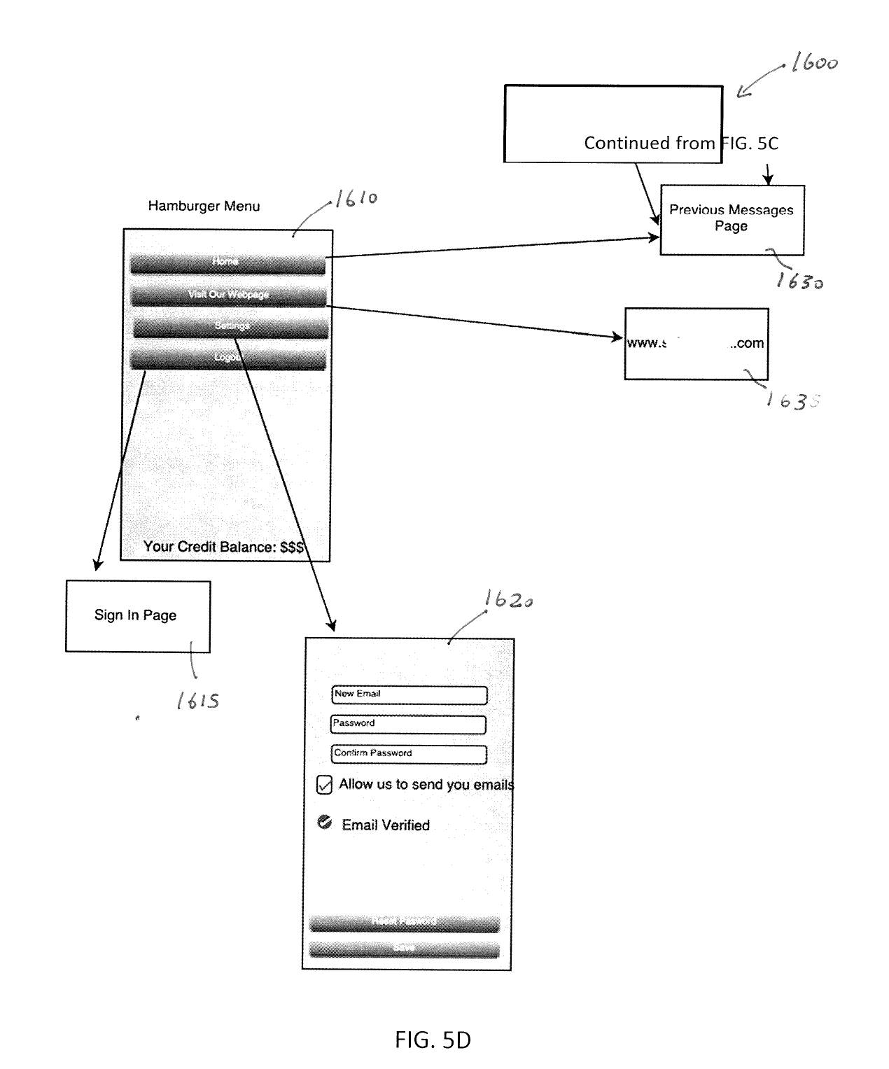

In some embodiments, users can download an application from an application store such as the iTunes® store and/or from a remote server and/or cloud service. In some embodiments, users can sign up for the application using social media logins or other conventional log in techniques. (iTunes® is a registered trademark of Apple Computer, Inc.) For example, FIGS. 5A-5D illustrate user application wireframe displays of the digital display system and method 100 of FIG. 1A in accordance with some embodiments of the invention. For example, referring to FIG. 5A wireframe displays 1300 of a user device 850 with display screen 855 can comprise display 1310 including a sign-in or sign-up option with username and password entries. In some embodiments, the wireframe displays 1300 can include display 1320 that can be displayed when a user chooses to sign up. The display 1320 can include an accept terms of service (TOS) toggle, with a display of TOS display 1325 provided a choice of accept or cancel to the user. In some embodiments, after a user selects sign-on, or has already previously signed on, the wireframe displays 1300 can include display 1330 including one or more previous messages with image and with status and billboard. In some embodiments, the wireframe displays 1300 can include display 1340 where a user can review the image and time/cost/refunded values for any image. In some embodiments, the wireframe displays 1300 can include display 1350 comprising one or more selectable billboards.

In some embodiments, using the downloaded digital display system and method 100 application, the user can perform the following steps: (1). “select location”, where users see a list of billboard locations with address and screen dimensions for each. In some embodiments, the users can tap a desired screen location to proceed, and (2). “schedule your message”, where the users see a schedule of dates and times available for purchase. Times already purchased by other users are marked as sold. In some embodiments, the user can select one or multiple time slots. Once a time slot is tapped, that slot is held for 5 minutes (a countdown clock can be shown) to allow the user to complete the purchase. If time expires before the user completes the purchase, the user is notified and is then sent back to the “select time” screen. After the user selects a desired time(s), a “next” tap can take the user to the upload message screen. Using step (3), the user can upload messages. In some embodiments, the technologies used for the application for the client side and server side can include: AWS EC2 CentOS Dedicated Server, Apache 3, MySQL™, PHP, Objective C (iOS), Ionic, Bower, Nodejs™, Apache Cordova™, and Android SDK.

In some embodiments, users can upload images at least three ways including by taking a new photo with their device's camera, selecting a photo from their camera roll, or select an image they previously used on the application. After selecting, the user can see how the image fits on the selected billboard. The user then has an option to add text to an image. If the user finds the image and text acceptable, the user can tap “next” to proceed to confirm the message screen. In some embodiments, step (4). includes a preview and confirm step where users can preview their final message. In some embodiments, the user can see the name of the board, time(s) the message will appear, and the cost of their purchase. In some embodiments, users can go back and edit schedule and/or message, or tap confirm to proceed to pay. With step (5). “pay”, users have the option of paying via PayPal, credit card, or with Apple Pay. Users can see a congratulations screen once upload and payment are successful. A tap sends them to a “Your Messages” screen where they can check status of their messages (Approved/Rejected) and time(s) scheduled to run. After the message runs, the user can see a link to a download/share online a photo of their message as it appeared on the actual billboard. In some embodiments, a high resolution photo includes the context of the location (people on sidewalk, cars in the street, etc.)

FIG. 5B includes wireframe displays 1400 including display screen 1410 configured to display an image. In some embodiments, the wireframe displays 1400 can include display 1420 comprising a select time page and order in bulk option. In some embodiments, the wireframe displays 1400 can include display 1425 comprising a select package display 1425 providing the user an option to select one or more packages. In some embodiments, the wireframe displays 1400 can include display 1430 including a select image display configured for adding, selecting previous images or moving forward. In some embodiments, the wireframe displays 1400 can include display 1435 providing a user an option to add an image, add text, select a camera roll, take a picture, or move forward. In some further embodiments, the wireframe displays 1400 can include display 1440 including add text options. The display 1440 can include options to add text, and select font family, font color, background color, and position on the display. In some embodiments, the wireframe displays 1400 can include display 1445 for selecting one or more images.

In some embodiments, a user can (1). sign up with their email address, where email verification is necessary only if the user wants to receive emails with the picture of their uploaded image on the billboard, (2). upload a new message, (3). select a billboard, (4). select times for the image to be displayed, and (5). select an image, (where for a new image, this image will need to be approved, followed by user selection of an image, followed by adding text to the image, and where for an old image, the image doesn't need to be approved if it has already been previously approved, and where a user can select an image that hasn't been rejected). Further steps can include (6). confirm purchase, where in some embodiments, a purchase is made using a Braintree™ payment system that allows the use of Credit/Debit Cards, PayPal®, Venmo®, or Apple Pay® (if on iOS). Further steps can include (7). check previous messages, time, and status, and (8). send email to the user with a picture of the billboard with their image. Even if the user doesn't want the email, they still can see the image by clicking on their time when looking at their previous messages. As shown in FIG. 5C, the digital display system and method 100 can include wireframe displays 1500 including display screen 1510 that can include a confirmatory display including image, billboard, price, times and cost table, options for promo codes, and optional recipient email, and including a confirm selector. In some embodiments, a payment system (process 1520) can be used to cancel payment, and display 1530 and/or display 1540 can be displayed based on whether or not messages were scheduled for display. In some further embodiments, as shown in FIG. 5D, the digital display system and method 100 can include wireframe displays 1600 including display screen 1610 that can include a sign-in 1615 and user selectable access to process 1630 to a previous message page and/or process 1635 to a digital display system and method 100 website. Further, display screen 1620, accessed from a settings selector can include a display of email, password, password confirmation, sign-up for email communications, and password reset options. PayPal® and Venmo® are registered trademarks of PayPal, Inc. Apple Pay® is a registered trademark of Apple Inc.

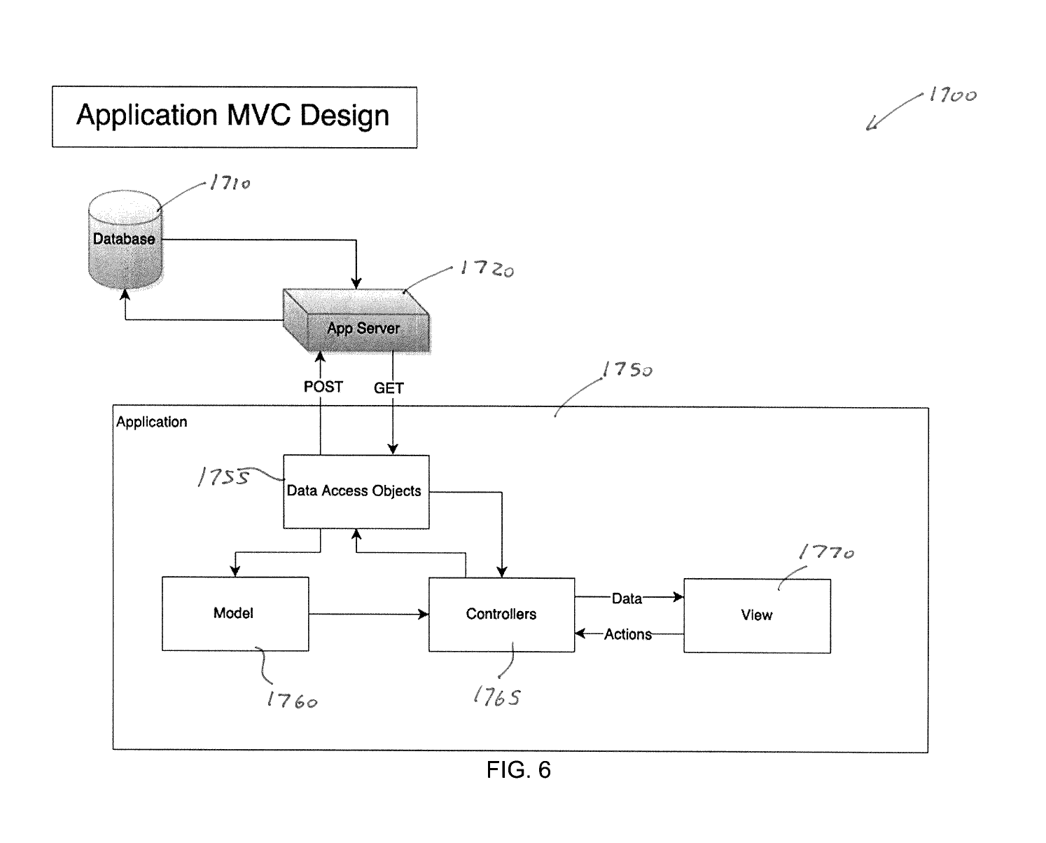

FIG. 6 shows a database and server architecture 1700 for operating at least a portion of the digital display system and method 100 of FIG. 1A according to one embodiment of the invention. In some embodiments, an application server 1720 can be coupled to a database 1710 for storing and retrieving data related to one or more images selectable for billboard display. In some embodiments, the application server 1720 can operate processes 1750 of an application for one or more digital displays including process 1755 comprising data access objects, and model 1760 with controllers 1765 for view process 1770 for display of billboard images and/or messages from a user, operator, or administrator.

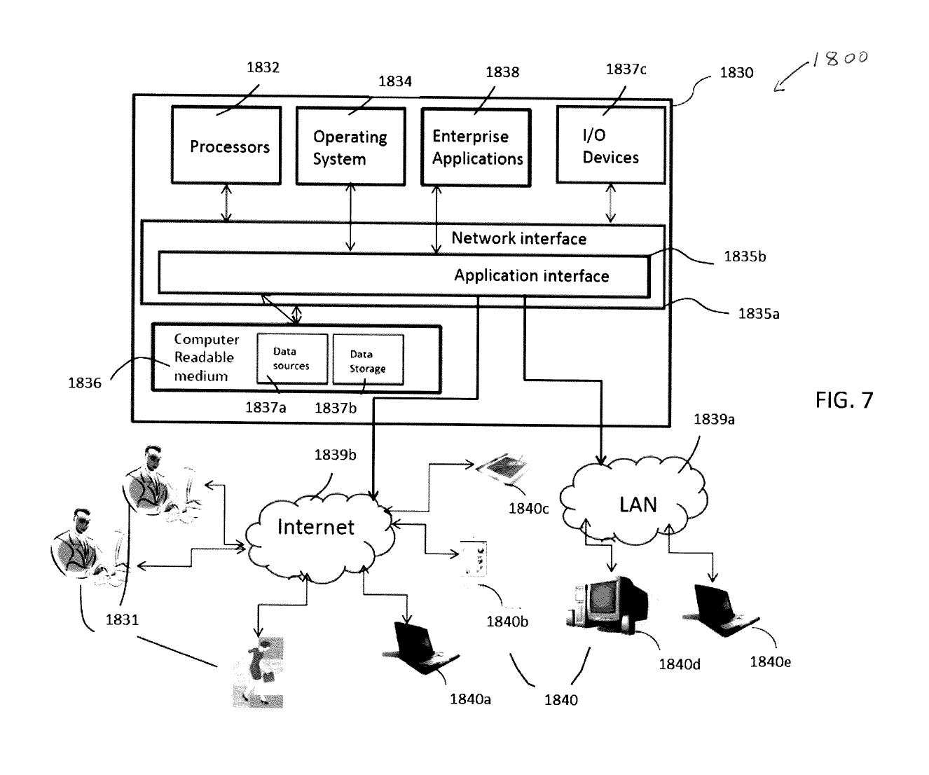

FIG. 7 shows a system for operating a digital display system and method 100 of the system architecture of FIG. 1A according to one embodiment of the invention. The architecture diagram 1800 of FIG. 7 shows one example of a system 1830 for performing one or more of the methods of the digital display system and method 100 according to at least one embodiment of the invention. In some embodiments, the database and server architecture 1700 can comprise at least a portion of the system 1830. As shown, the system 1830 can include at least one computing device, including one or more processors. Some processors can include processors 1832 residing in one or more conventional server platforms. In some embodiments, the system 1830 can include a network interface 1835a and/or an application interface 1835b coupled to at least one processor 1832 capable of running at least one operating system 1834, and one or more of the software modules 1838 (e.g., such as enterprise applications). In some embodiments, the software modules 1838 can include server-based software platform that can include digital display system and method 100 software modules suitable for hosting at least one user account and at least one client account, as well as transferring data between one or more accounts.

Some embodiments of the invention relate to or include a device or an apparatus for performing these operations of the operating system 1834 and/or the software modules 1838. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data are obtained over a network the data can be processed by other computers on the network, e.g. a cloud of computing resources.

With the above embodiments in mind, it should be understood that the invention can employ various computer-implemented operations involving digital display system and method 100 data stored in computer systems. Moreover, the above-described databases and models throughout the digital display system and method 100 can store analytical models and other data on computer-readable storage media within the system 1830 and on computer-readable storage media coupled to the system 1830. In addition, the above-described applications of the digital display system and method 100 system can be stored on computer-readable storage media within the system 1830 and on computer-readable storage media coupled to the system 1830. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

Some embodiments include the system 1830 comprising at least one computer readable medium 1836 coupled to at least one data storage device 1837b, and/or at least one data source 1837a, and/or at least one input/output device 1837c. In some embodiments, the invention embodied by the digital display system and method 100 can be embodied as computer readable code on a computer readable medium 1836. The computer readable medium 1836 can be any data storage device that can store data, which can thereafter be read by a computer system (such as the system 1830). Examples of the computer readable medium 1836 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor (including processors 1832).

In some embodiments of the invention, the computer readable medium 1836 can also be distributed over a conventional computer network via the network interface 1835a so that the digital display system and method 100 embodied by the computer readable code can be stored and executed in a distributed fashion. For example, in some embodiments, one or more components of the system 1830 can be tethered to send and/or receive data through a local area network (“LAN”) 1839a. In some further embodiments, one or more components of the system 1830 can be tethered to send or receive data through an internet 1839b (e.g., a wireless internet). In some embodiments, at least one software application 1838 running on one or more processors 1832 can be configured to be coupled for communication over a network 1839a, 1839b. In some embodiments, one or more components of the network 1839a, 1839b can include one or more resources for data storage, including any other form of computer readable media beyond the media 1836 for storing information and including any form of computer readable media for communicating information from one electronic device to another electronic device.

In some embodiments, the network 1839a, 1839b can include wide area networks (“WAN”), direct connections (e.g., through a universal serial bus port) or other forms of computer-readable media 1836, or any combination thereof. Further, in some embodiments, one or more components of the network 1839a, 1839b can include a number of client devices which can be personal computers 1840 including for example desktop computers 1840d, laptop computers 1840a, 1840e, digital assistants and/or personal digital assistants (shown as 1840c), cellular phones or mobile phones or smart phones (shown as 1840b), pagers, digital tablets, internet appliances, and other processor-based devices. In general, a client device can be any type of external or internal devices such as a mouse, a CD-ROM, DVD, a keyboard, a display, or other input or output devices 1837c. In some embodiments, various other forms of computer-readable media 1836 can transmit or carry instructions to a computer 1840, including a router, private or public network, or other transmission device or channel, both wired and wireless. The software modules 1838 can be configured to send and receive data from a database (e.g., from a computer readable medium 1836 including data sources 1837a and data storage 1837b that can comprise a database), and data can be received by the software modules 1838 from at least one other source. In some embodiments, at least one of the software modules 1838 can be configured within the system to output data to a user 1831 via at least one digital display (e.g., to a computer 1840 comprising a digital display).

In some embodiments, the system 1830 as described above can enable one or more users 1831 to receive, analyze, input, modify, create and send data to and from the system 1830, including to and from one or more enterprise applications 1838 running on the system 1830. Some embodiments include at least one user 1831 coupled to a computer 1840 accessing one or more modules of the digital display system and method 100 including at least one enterprise applications 1838 via a stationary I/O device 1837c through a LAN 1839a. In some other embodiments, the system 1830 can enable at least one user 1831 (through computer 1840) accessing enterprise applications 1838 via a stationary or mobile I/O device 1837c through an internet 1839a.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, are intended to be encompassed by the invention.

1. A billboard display system comprising:
a computer system including at least one processor and at least one coupled billboard display configured for at least partial, remote control by a viewing user using a messaging application.

2. The system of claim 1, further comprising a digital display control system coupled to at least one source of billboard control data, the digital display control system comprising a link to a billboard image server coupled to a command interface of the messaging application.

3. The system of claim 2, wherein at least a portion of the at least one coupled billboard display is configured to respond to the control data through the command interface based at least in part on billboard information provided by the viewing user and the billboard image server.

4. The system of claim 1, wherein the system is configured to receive input from a viewing user positioned within a viewing distance and line of sight of the billboard and actually physically observing at least a portion of the billboard display by looking at or towards the billboard display.

5. The system of claim 1, wherein the billboard information provided by the viewing user is based on an observation of the billboard display.

6. The system of claim 5, wherein the billboard information provided by the viewing user is based on the viewing user's observation of the billboard display, and anything currently displayed on the billboard display is based on the billboard information previously provided to the digital display control system by the viewing user.

7. The system of claim 1, further comprising at least one camera coupled to the billboard image server.

8. The system of claim 7, wherein the at least one camera is positioned in a line of sight of at least a portion of the billboard display.

9. The system of claim 8, wherein the billboard information is based at least in part on the viewing user viewing at least a portion of the billboard display via the at least one camera.

10. The system of claim 9, wherein the billboard information is one or more images of the billboard display taken by the at least one camera.

11. The system of claim 9, wherein the digital display control system is configured to transmit a push notification to a coupled device of the viewing user indicative of a billboard display of billboard information provided at least in part by the viewing user.

12. The system of claim 1, wherein the billboard display is configured to be updated by the digital display control system using the billboard information based on one or more specified times or intervals.

13. The system of claim 12, wherein the specified times or intervals are controlled by the viewing user.

14. The system of claim 1, wherein at least a portion of the at least one coupled billboard display is configured to respond to the control data within one or more specified timeslots.

15. The system of claim 14, wherein the time slots are saleable to the viewing user; and wherein anything currently displayed on the billboard display is based on the billboard information provided to the digital display control system based on one or more purchased time slots.

16. A billboard display server system comprising:
a computing device comprising at least one processor;
a non-transitory computer readable medium, having stored thereon, instructions that when executed by the computing device, cause the computing device to perform at least some operations within a billboard controller that modify at least a portion of a billboard display at least partially under remote control by a viewing user.

17. The billboard display server system of claim 16, wherein the operations comprise at least:
execution of a browser program to deliver user-selectable messaging content on a local or consumer device;
displaying at least one selectable option of a billboard message to a viewing user;
receiving input from the viewing user through the local or consumer device and storing the received selection in a data repository;
operating a digital display control system to fetch billboard image data from a billboard image server based at least in part on the received selection; and
updating the billboard display based at least in part on the received input provided by the viewing user and the billboard image server.

18. The server system of claim 17, further comprising at least one camera coupled to the billboard image server, the at least one camera is positioned in a line of sight of at least a portion of the billboard display.

19. The server system of claim 18, wherein the billboard update is based at least in part on the viewing user viewing at least a portion of the billboard display from one or more images of the billboard display taken by the at least one camera.

20. The server system of claim 17, wherein the digital display control system is configured to transmit a push notification to the local or consumer device indicative of a billboard display of the input provided by the viewing user.

21. The server system of claim 17, wherein the digital display control system updates the billboard display based on one or more specified times or intervals provided by the viewing user.

22. A server system of claim 21, wherein updates of the billboard display occur between timeslots.

23. A server system of claim 22, wherein the timeslots include viewing user purchased timeslots.
